(19) United States
(12) Patent Application Publication
(10) Pub. No.: US 2011/0297017 A1
(43) Pub. Date: Dec. 8, 2011

(54) COMPACTING WASTE CONTAINER

(76) Inventors: Jeff BROWN, Mifflintown, PA (US); Israel WEISS, Brooklyn, NY (US)

(21) Appl. No.: 13/170,228

(22) Filed: Jun. 28, 2011

Related U.S. Application Data
(63) Continuation-in-part of application No. 12/882,319, filed on Sep. 15, 2010.

(51) Int. Cl. B65F 1/14; B30B 7/00; B65F 1/12; B30B 15/30

(52) U.S. Cl. 100/237; 100/215; 100/35

(57) ABSTRACT

A trash compaction container and system is disclosed. The trash container includes a compaction system that manually reduces the volume of trash disposed within the trash container.

### RELATED APPLICATION

This application is a continuation-in-part and claims priority from and the benefit of U.S. Non-Provisional application Ser. No. 12/882,319, entitled COMPACTING WASTE CONTAINER, filed Sep. 15, 2010, which is hereby incorporated by reference.

### BACKGROUND

The application generally relates to a waste or trash bin, and more specifically to a waste container that compacts waste.

In the past, trash baskets were provided as a simple container or basket. Such baskets were placed in kitchens and elsewhere for the temporary storage of kitchen, bathroom or general household trash, before being removed from the household for general home pickup or removal. The baskets may or may not have included a removable liner.

The garbage contained in these conventional containers is usually loose and bulky so that the amount of void volume in the container is high, thus requiring early removal of the waste and less efficient use of any removable liners there within.

What is needed is a trash container that is economical and environmentally friendly that compacts trash so as to efficiently use a trash removable liner.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

The following embodiments and aspects thereof are described and illustrated in conjunction with systems and methods that are meant to be exemplary and illustrative, not limiting in scope. In various embodiments, one or more of the limitations described above in the Background have been reduced or eliminated, while other embodiments are directed to other improvements.

A first embodiment of the disclosure includes a trash container, including a bin at least partially defining an interior surface having an interior space. The bin has a top, a bottom, and an opening formed in the top in communication with the interior space. The bin is configured to vertically support a liner on or near the top of the bin, with the liner being substantially contained within the interior space of the bin. A compaction member is securable to an exterior surface of the bin between the top and the bottom of the bin. The compaction member is configured for insertion in the interior space of the bin to compact an amount of trash disposed within the interior space of the bin.

Another embodiment of the disclosure includes a trash compaction system, including a liner defining an interior surface having an interior space. A trash container includes a bin at least partially defining an interior surface having an interior space, the bin having a top, a bottom, and an opening formed in the top in communication with the interior space. The bin is configured to vertically support the liner on or near the top of the bin, with the liner being substantially contained within the interior space of the bin. A compaction member is securable to an exterior surface of the bin between the top and the bottom of the bin. The compaction member is configured for insertion in the interior space of the bin to compact an amount of trash disposed within the interior space or of the liner. The compaction member is configured to reduce the volume of trash contained within the liner upon insertion of the compaction member in the interior space of the liner and directed movement of the compaction member toward the bottom of the bin.

A further embodiment of the disclosure includes a method of trash compaction includes providing a bin having a top and a bottom, the bin at least partially defining an interior surface having an interior space. The method further includes forming at least one opening in the bin near the bottom. The method further includes vertically supporting a liner at least partially in the interior space at or near the top of the bin, the liner defining an interior surface having an interior space. The method further includes inserting a compaction member in the interior space of the liner, and directing the compacting member toward the bottom of the bin.

Alternative exemplary embodiments relate to other features and combinations of features as may be generally recited in the claims.

### BRIEF DESCRIPTION OF THE FIGURES

FIG. 1 illustrates an embodiment of a trash container according to the invention.

FIG. 2A illustrates a side view of the trash container of FIG. 1.

FIG. 2B illustrates a side view on another embodiment of a trash container according to the invention.

FIG. 3 illustrates a trash container system including the trash container of FIG. 1.

FIG. 4A illustrates a partial cut away side view the trash container system of FIG. 3 during a compaction cycle.

FIG. 4B illustrates a partial cut away side view of another embodiment of a trash container system during a compaction cycle.

FIG. 5 illustrates an alternate embodiment of a trash container according to the invention.

FIG. 6 illustrates a side view of the embodiment of FIG. 5 of a trash container according to the invention.

FIGS. 7 and 8 illustrate further alternate embodiments of a trash container according to the invention.

FIG. 9 illustrates an embodiment of a compaction member according to the invention.

FIG. 10 illustrates an alternate embodiment of a compaction member according to the invention.

FIG. 11 illustrates a securing device for use with a compaction member according to the invention.

### DETAILED DESCRIPTION OF THE EXEMPLARY EMBODIMENTS

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present disclosure provides novel solutions for temporary trash storage and trash compaction. As used herein, the term “trash compaction” means to reduce the volume of an amount of trash.

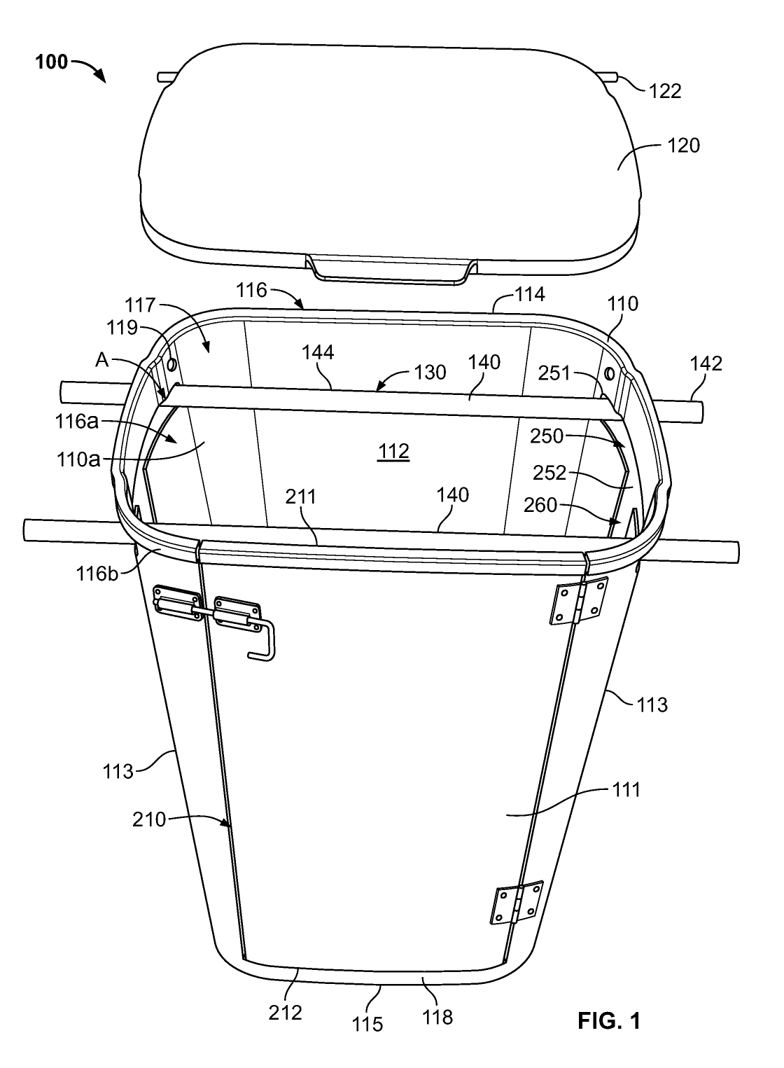

FIG. 1 illustrates an overview of the present invention, in accordance with various embodiments. As illustrated in FIG. 1, an embodiment of a trash container 100 according to the present invention. The trash container 100 includes a bin 110, a lid 120, and a trash compacting system 130. The bin 110 includes an interior surface 110a, a front side 111, a rear side 112 and opposing sides 113 there between. The bin 110 further includes a top 114 and a bottom 115. The bin further includes a top rim 116 and a lower rim 118. The top rim 116 defines a top opening 116a to the interior space 117. The bin 110 at least partially encloses and defines an interior space 117. In this exemplary embodiment, the trash container 100 has a generally rectangular cross section. In another embodiment, the trash container 100 may have a square, circular, oval or other cross section. The trash container 100 may be formed of natural materials, such as, but not limited to wood, or synthetic material, such as, but not limited to plastics, polymers, ceramics, metals and metal alloys. For example, the trash container 100 may be formed of polyvinyl chloride (PVC).

In this exemplary embodiment, the trash container 100 includes a door 210. The door is disposed in the front side 111. The door 210 includes a top edge 211, a bottom edge 212, and opposing side edges 213. The door 210 is attached to the bin 110 by a pivotal attachment device 222 attached to the door along one of the side edges 213. In this exemplary embodiment, the pivotal attachment device 222 is a pair of hinges. In another embodiment, the pivotal attachment device 222 may be, but not limited to, hinges, flexible straps, or other pivotally rotational devices. Additionally, the door 210 is secured in a closed position, as shown in FIG. 1, by a fastener 224. In this exemplary embodiment, the fastener 224 is a latch. In another embodiment, the fastener 224 may be, but is not limited to a pin and receiver, hook and loop, or other closure device. In another embodiment, the fastener 224 may be a long vertical latch extending the length of the door 210 and latch into the lower rim 118. The long vertical latch may add stability to the door 210. The hinged side of the door will have enough stability). In another embodiment, the door 210 may be secured by friction, and no fastener 224 is used. Furthermore, in this exemplary embodiment, the door 210 pivots on a vertical axis. In another embodiment, the door 210 pivots on a horizontal axis. For example, the door 210 may be attached to the bin 110 by a pivotal attachment device 222 along the bottom edge 212, such that the door 210 pivots or swings out from the bin from the top edge 211. The door 210 is positioned above the lower rim 118 in a manner that any fluid in on the bottom interior space i.e., spillage (not shown) may be retained in the bin 110. In another embodiment, the door 210 may be disposed in the rear side 112 or one of the opposing sides 113. In yet another embodiment, the trash container 100 may not include a door 210.

The lid 120 includes protrusions 122. In this exemplary embodiment, the lid 120 is removably attachable to the bin 110 by protrusions 122, which are received in openings 119 in the opposing sides 113 of bin 110. In this configuration, the lid 120 pivots about the protrusions 122 so as to swing up and away from the front side 111 to open the interior space 117 so as to receive trash or to remove the removable liner 310 from the interior space 117. In another embodiment, the lid 120 may be attached to the bin 110 by an attachment device. In one embodiment, the lid 120 may be pivotally attached to the bin 110 by a pivotal fastener, such as, but limited to a hinge. In yet another embodiment, the lid 120 may be optional to the trash container 100. In yet another embodiment, the trash container 100 does not include a lid 120.

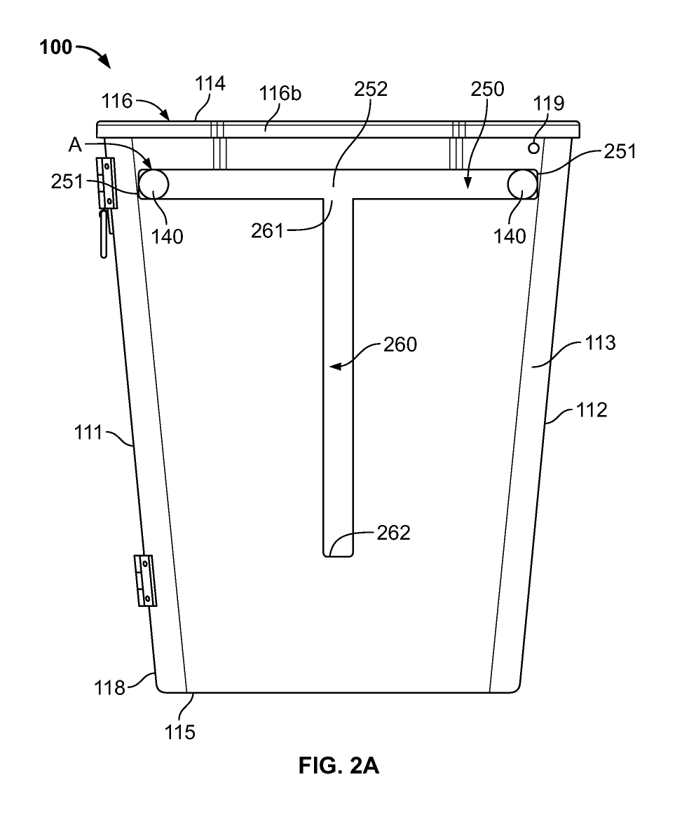

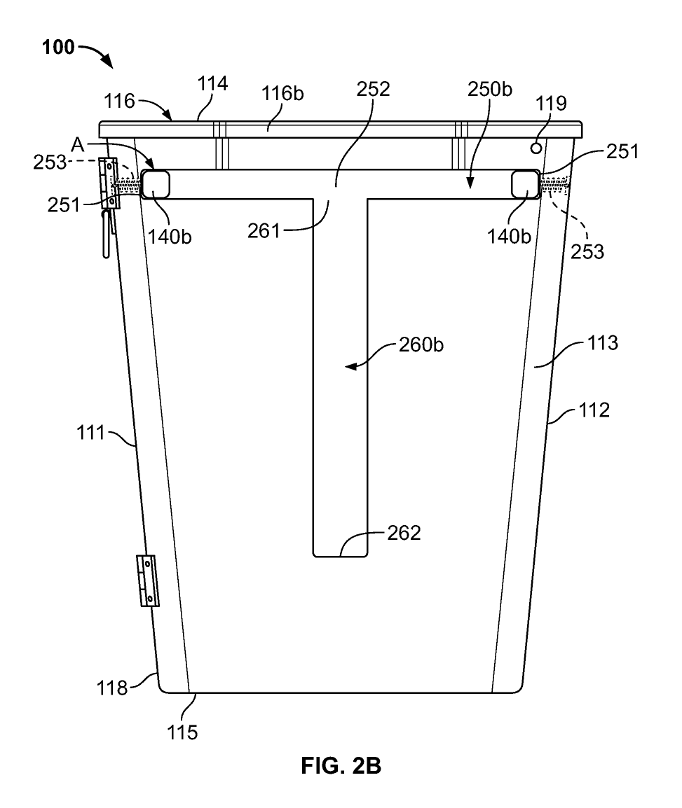

FIG. 2A shows a side view of the trash container 100. As can be seen in FIGS. 1 and 2A, each of the opposing sides 113 includes a horizontal slot 250 and a vertical slot 260. In such a manner, each horizontal slot 250 is opposite an opposing horizontal slot 250. The horizontal slot 250 includes ends 251 and a midpoint 252. The horizontal slot 250 is proximate to the top 114. As defined herein, proximate to the top 114 means less than about 10% of the vertical length of the opposing sides 113. In another embodiment, proximate the top means less than about 5% of the vertical length of the opposing sides 113. In this exemplary embodiment, each horizontal slot 250 is substantially horizontally level. In another embodiment, each horizontal slot 250 is inclined downwards towards the vertical slot 260 of that side. Each side's vertical slot 260 is in open communication with the horizontal slot 250 of that side. The vertical slot 260 includes a top end 261 and a bottom end 262. The vertical slot 260 extends from the horizontal slot 250 towards the bottom 115.

Referring to FIGS. 1 and 2A, the trash compacting system 130 includes compaction members 140. The compaction members 140 extend between and through the two opposing sides 113. Each of the compaction members 140 includes a handle portion 142 and a compaction portion 144. The handle portion 142 is disposed exterior to the bin 110, and the compaction portion 144 is disposed in the interior of the bin 110. The compaction members 140 are sized to move horizontally through the horizontal slot 250 from end 251 to midpoint 252 and through the vertical slot 260 from the top end 261 to the bottom end 262. In this exemplary embodiment, the compaction members 140 are sized to move vertically adjacent to one another through the vertical slots 260, or in other words, compaction members 140 are too wide when horizontally adjacent to fit in the vertical slot 260. In this exemplary embodiment, the compaction members 140 have a general rod shape and generally circular cross section. In another embodiment, one or both of the compaction members 140 may have, but are not limited to, a generally oval, square, rectangular, hexagonal or other geometric cross section. In another embodiment, a track system (not shown) is to support the compaction members 140 in the horizontal and/or vertical slots 150, 260. In such a manner, the compaction members 140 may slide along the track supported. The compaction members 140 may be or permanently or removably attached to the track.

In another embodiment shown in FIG. 2B, the compaction members 140 have square cross section and sized to move horizontally adjacent to one another downward through the vertical slot 260. In this manner, the compaction members 140 remain horizontal to each other while traveling vertically downward, thus increasing the compaction area and force applied to the trash and trash bag.

As shown in FIGS. 1 and 2A, the compaction members 140 are positioned proximate to the ends 251 of each opposing horizontal slot 250, otherwise known as in open position “A”. In this exemplary embodiment, the compaction members 140 are manually moved across each opposing sides 113 horizontal and vertical slot 250, 260. In another embodiment, and as shown in FIG. 2B, the compaction members 140 may be mechanically urged towards ends 251 by a return device 253. In this exemplary embodiment, the return device 251 is a spring attached at one end to bin 110 and at the opposite end to compaction members 140. In another embodiment, the return device 253 may be a band or other resilient component capable of resiliently urging the compaction members 140 or devices towards ends 251. In such a manner, the springs may urge the compaction members 140 towards ends 251 of horizontal slot 250 in an open position A.

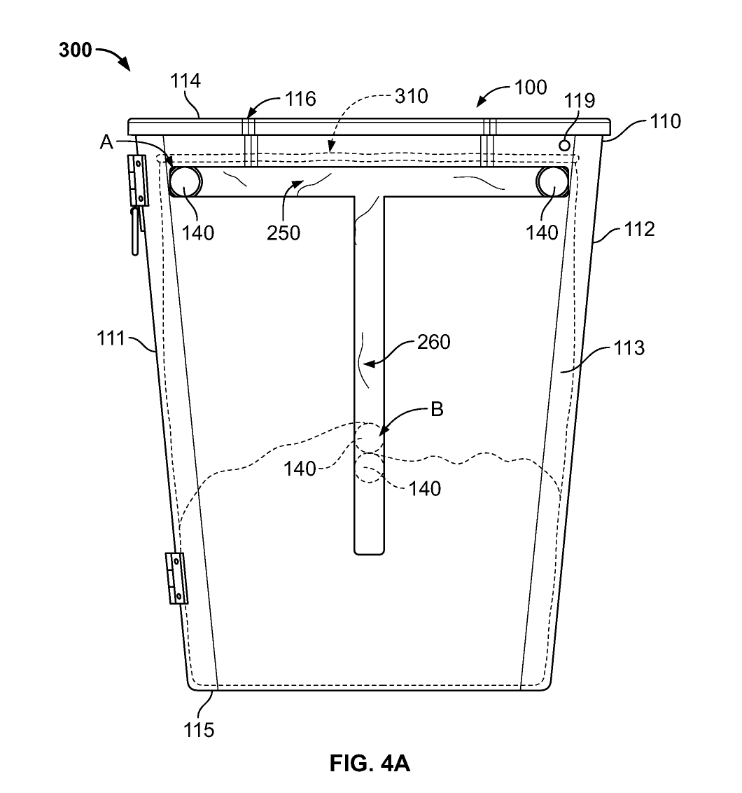

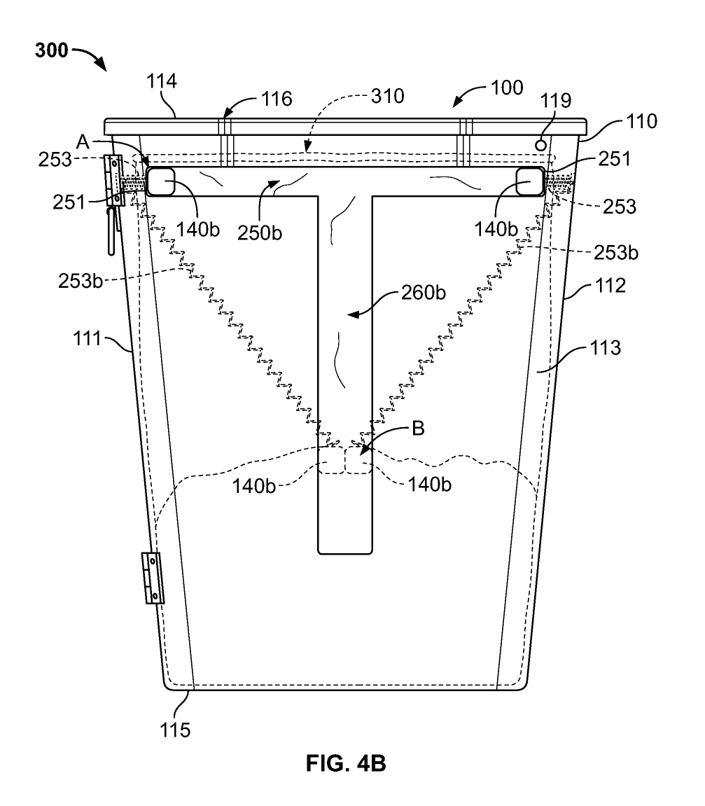

FIG. 2B illustrates another embodiment of the trash container 100 including compaction members 140b. As can be seen in FIG. 2B, the compaction members 140b have a square cross section. In this embodiment, the vertical slot 260b has been widened to receive compaction members 140b in a side-by-side arrangement (see FIG. 4B). Also in this embodiment, the compaction members 140b are attached to the front and rear sides 111, 112 by a return device 253. The return device 253 is a spring that has been attached the compaction members 140b and the front and rear sides 111, 112 so as to urge the compaction members 140 towards either ends 251, respectively.

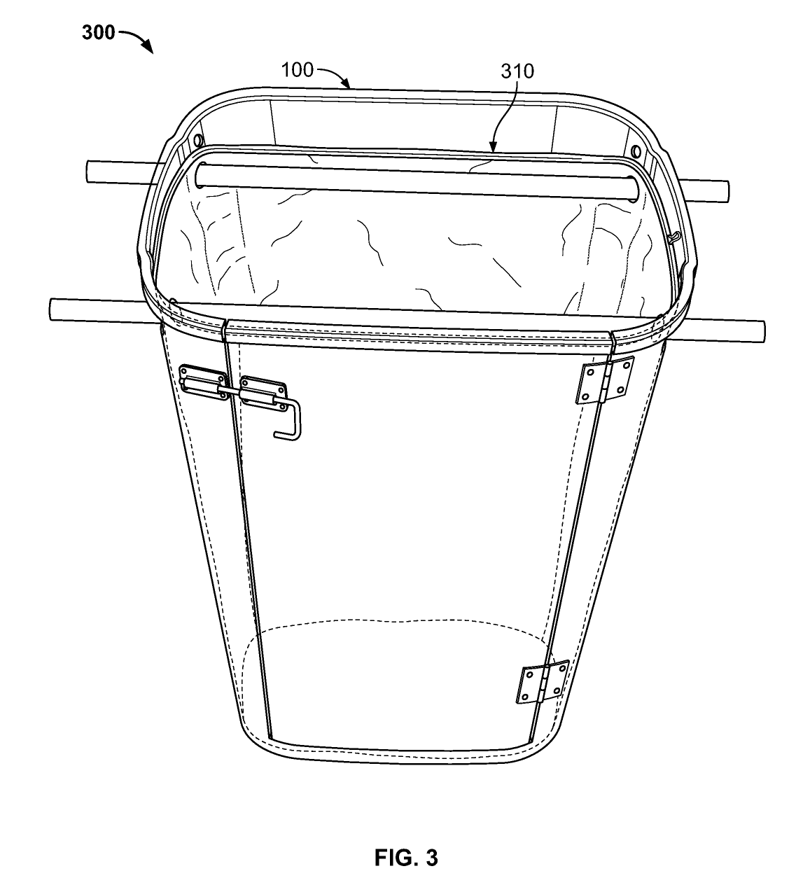

FIG. 3 shows a trash compaction system 300 according to an embodiment of the invention. As can be seen in FIG. 3, the trash compaction system 300 includes the trash container 100 and a removable liner 310 disposed within the trash container 100. The removable liner 310 includes an opening 312 and can generally be referred to as having a bag or sack configuration. As can be seen in FIG. 3, the trash compaction system 300 is in an open configuration having the trash container 100 in an open position A and the removable liner 510 configured to receive trash placed into the interior space 117 of the bin 110. The trash compaction system 300 is shown without optional lid 120.

As can be seen in FIG. 3, the removable liner 310 includes openings 312 configured to receive the compaction members 140, such that the removable liner 310 is supported within the interior space 117 of the bin 110. In another embodiment, the removable liner 310 is removably attached to the compaction members 140 by attachment devices, such as, but not limited to, hooks, loops, straps, hook and loop straps, or other similar system for temporarily affixing the removable liner 310 to the compaction members 140.

FIG. 4A shows a partial side view of the trash compaction system 300. As can be seen in FIG. 4A, the opening 312 of the removable liner 310 is closed when the compaction members 140 are moved across the horizontal slot 250 to the midpoint 252 and moved down the vertical slot 260. The compaction members 140 move down the vertical slot 260 to collapse the removable liner 310 upon itself and compress trash within the removable liner 310 while moved to a compaction position B. When the removable liner 310 is considered full, or otherwise desirable to be removed from the trash compaction system 300, the removable liner 510 is detached from the compaction members 140 by withdrawing the compaction members 140 outward from the bin 110 via the horizontal slot 250 to permit the compaction members 140 to be withdrawn from the openings 512. The removable liner 310 may then be removed from the trash container 100 via top opening 116a or via a front opening defined by opening the door 210.

In another embodiment of the trash compaction system 300 shown in FIG. 4B, the compaction members 140b are moved across the horizontal slot 250b to the vertical slot 260b and moved downward through the vertical slot 260b in a side-by-side horizontal arrangement. In such an arrangement, the compaction members apply force to a greater area of the trash compared to if the trash compaction members 140b were in a side-by-side vertical arrangement. In this exemplary embodiment, return devices 253 urge the compaction members 140b towards ends 251 from an extended arrangement 253B during a trash compaction cycle. In this exemplary embodiment, the compaction members 140b have a square cross section. In another embodiment, the compaction members 140b may have a circular, oval, rectangular, hexagonal or other geometric cross section.

In another embodiment, the removable liner 310 is not attached to the compaction members 140, but is attached to the top rim 116 by overlapping and folding over the top rim 116 so as to surround an outer surface 116b of the top rim 116. In another embodiment, the removable liner 310 is attached to the top rim 116 by a fastener, such as, but not limited to, hooks, straps, bands or other similar attachment devices. The removable liner 310 is further disposed between the compaction members 140 while in an open position A (FIG. 3) into the interior space 117 of the bin 110. In this embodiment, the trash compaction system 300 is operated by detaching the removable liner 310 from the top rim 116, positioning the removable liner 310 under the compaction members 140, and moving the compaction members 140 across the horizontal slot 250 and down the vertical slot 260 of each of the opposing sides 113 to a compaction position B (FIG. 4) so as to compact trash disposed within the removable liner 310 and brought into contact with the compaction members 140. The compaction members 140 may then be returned to ends 251 and the removable liner 310 re-attached to the top rim 116 to further receive trash or the removable liner 310 may be removed from the bin 110 for disposal.

In yet another embodiment, the removable liner 310 is not attached to the compaction members 140, but is attached to the interior surface 110a of bin 110. The removable liner 310 may be attached to the interior surface 110a by a fastener, such as, but not limited to, hooks, straps, bands or other similar attachment devices. In this embodiment, the trash compaction system 300 is operated by detaching the removable liner 310 from the interior surface 110a, positioning the removable liner 310 under the compaction members 140, and moving the compaction members across the horizontal slot 250 and down the vertical slot 260 of each of the opposing sides 113 to a compaction position B (FIG. 4) so as to compact trash disposed within the removable liner 310 and brought into contact with the compaction members 140. The compaction members 140 may then be returned to ends 251 and the removable liner 310 re-attached to the interior surface 110a to further receive trash or the removable liner 310 may be removed from the bin 110 for disposal.

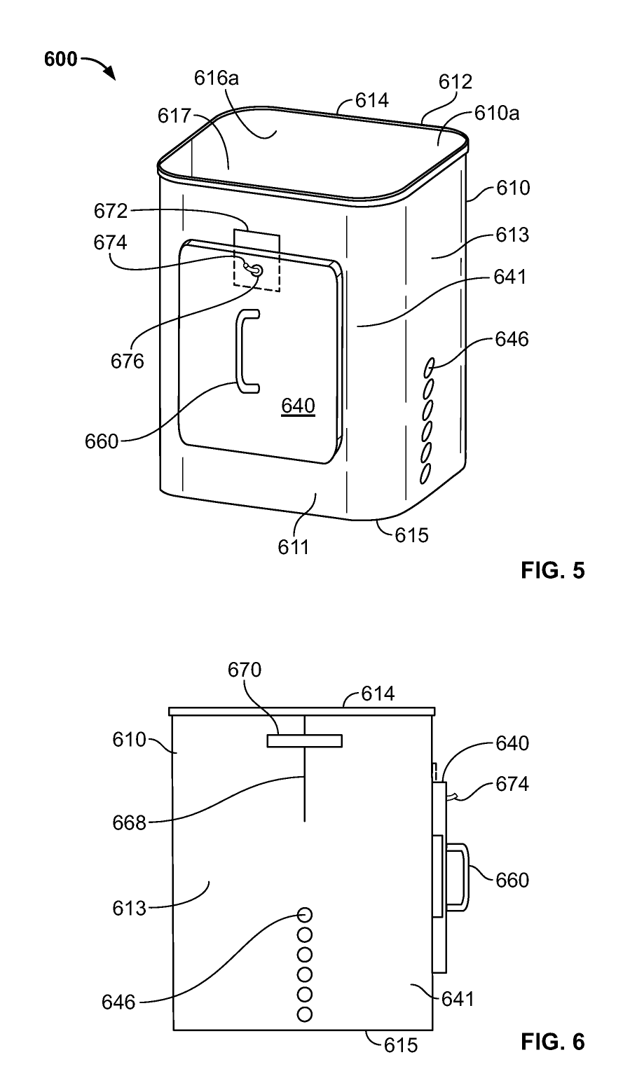

FIG. 5 shows an upper perspective view of an alternate embodiment of a trash container 600 of the present disclosure. The trash container 600 includes a bin 610 further including an interior surface 610a, a front side 611, a rear side 612 and opposing sides 613 there between. The bin 610 further includes a top 614 and a bottom 615. The bin further includes a top opening 616a to the interior space 617. The bin 610 at least partially encloses and defines an interior space 617. In this exemplary embodiment, as shown, the trash container 600 has a generally rectangular cross section. In another embodiment, the trash container 600 may have a square, circular, oval or other cross section. The trash container 600 may be formed of natural materials, such as, but not limited to wood, or synthetic material, such as, but not limited to plastics, polymers, ceramics, metals and metal alloys. For example, the trash container 600 may be formed of polyvinyl chloride (PVC).

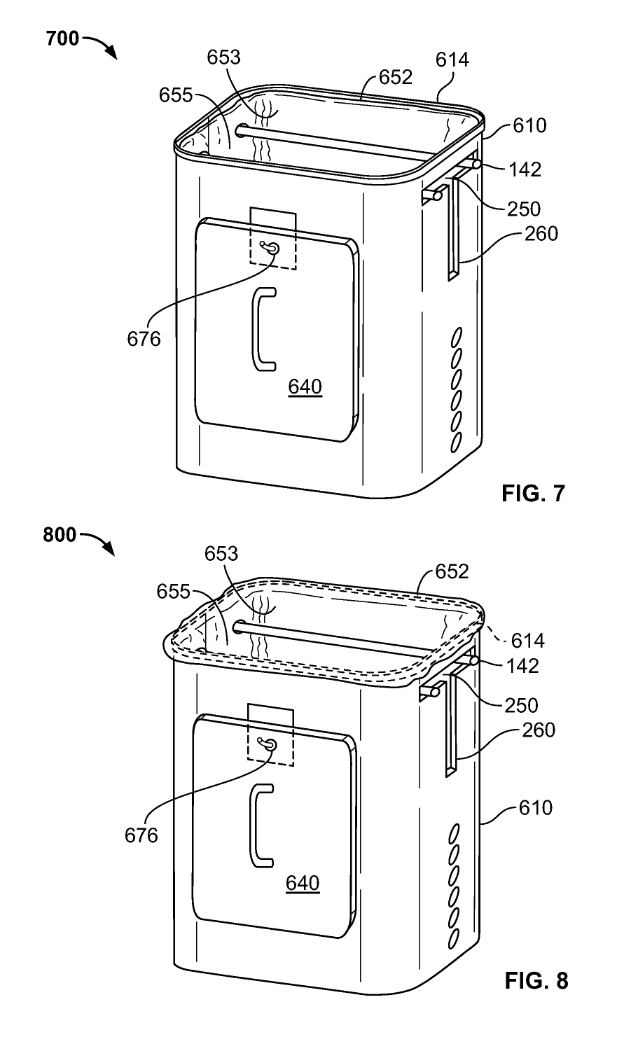

FIG. 6 shows a side view of the embodiment of FIG. 5. Opposing sides 613 include at least one opening 646 formed therethrough near the bottom 615 of the container 600. Six openings are shown in FIG. 6, although more or less than six openings may be utilized in each of sides 613. In another embodiment, the sizes of the openings may be different from each other. The openings 646 permit easier removal of a liner 652 (FIGS. 7, 8) that may be substantially filled with garbage, by substantially preventing a vacuum or lower pressure condition between the liner 652 and the container 600. In other words, openings 646 provide fluid communication between the interior of container 600, a liner 652 and the region exterior of the container 600, preventing the lower pressure condition from developing and interfering with removal of the liner 652 from the container 600. Alternately, or in addition to opening 646, at least one slit 668, such as shown formed in a wall of side 613, may also be employed to help prevent resistance to the removal of a filled liner 652 from the container 600. A clamp device 670 may be used to selectably maintain the slit 668 in an open or a closed position, as desired.

FIG. 6 further shows a compaction member 640 may be secured to an exterior surface 641 of the container 600 between the top 614 and the bottom 615 by virtue of a securing device 672, such as a hook 674 that extends through an opening 676 formed in a compaction device 640. It is to be understood that in other embodiments other arrangements may be used to secure the compaction member 640 to the container 600, such as Velcro®, a registered trademark owned by Velcro Industries B.V. of the Netherlands, or alternate mechanical fasteners and the like. Alternately, the compaction device 640 may be positioned at the top 614 of container 600, if desired, acting as a lid for the container 600, although a separate lid may be provided for the container in another embodiment. A handle 660 may be utilized to manipulate the compaction device 640.

It is to be understood that the compaction member is configured for insertion within the interior space of a bin and/or the interior space of a liner, such as a removable liner, in order to reduce the volume of garbage contained in the bin and/or liner, permitting additional garbage to be placed in the bin and/or liner, prior to removal of the garbage. The compaction member may be used by itself to perform this function, or may be used in combination with compaction members comprising rods, as previously discussed. For example, when the compaction member rods, such compaction members 142 are positioned in horizontal slots, such as slots 250 (FIG. 7), the compaction member 640 may be manipulated between the compaction members 142 or rods to compact the garbage in the bin and/or liner.

FIGS. 7 and 8 show alternate embodiments of trash compaction systems 700 and 800, respectively. For example, with trash compaction system 700, the bin 610 is configured to vertically support the liner 652 using a pair of rods 142 that extend through opposed horizontal slots formed in the side walls of the bin 610, and likewise extend through the liner 652, either through openings formed in the liner 652, or through pull-straps (not shown) which are provided with some liners 652. For purposes herein, the term vertically supported is intended to mean that the bin, such as bin 610, which could include rods 142, supports the liner 652 in an open position such that trash may be deposited through the opening and accumulate within an interior space 655 of the liner 652, the liner 652 defining an interior surface 653 having the interior space 655. In order to make the most efficient use of liner 652, i.e., to provide an opportunity to fill the liner 652 to the highest extent reasonably possible, bin 610 is configured to vertically support the liner 652 on or near the top 614 of the bin 610. Of course, bin 610 would be sized to receive liners of a predetermined capacity compatible with this objective. FIG. 8 is similar to FIG. 7, but additionally provides the opportunity to vertically support the liner 652 by virtue of the liner overlying the periphery of the top 614 of container 600.

It is to be understood that embodiments of the bin, and therefore the compaction systems of the present disclosure, such as compactions systems 130, 700 and 800, are configured to vertically support liners on or near the top of the bin, with the liner being substantially contained within the interior space of the bin. Vertical support is intended to include support of the liner by one or both of the periphery of the bin or rods protruding through both the bin and openings formed in the liner, whether the openings are formed through the wall of the liner or through openings or gaps between the liner wall and a pull-strap included with a liner.

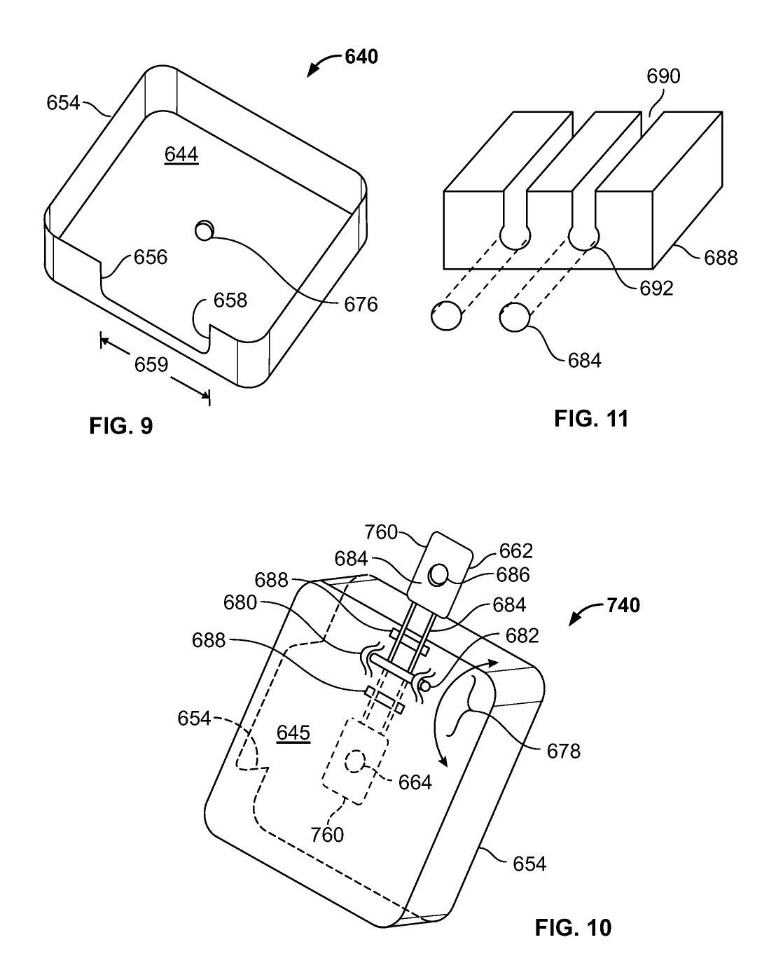

FIG. 9 shows an embodiment of compaction member 640. Compaction member 640 includes a first surface 644 and an opposed second surface 645 (such as shown in FIG. 10 for compaction member 740). As further shown in FIG. 9, a peripheral flange 654 extends away from and at an angle, such as about 90 degrees to first surface 644. In one embodiment, first surface 644 is substantially planar, although in other embodiments, the first surface may be nonplanar. Peripheral flange 654 includes a first edge 656 and a second edge 658, forming a spacing 659 therebetween, permitting compaction member 640 to be utilized as a dustpan. An opening 676 formed through the first surface 644, permits engagement of a securing device 672 (FIG. 5) to secure compaction member 640 to the exterior surface of the bin 610.

FIG. 10 shows an alternate embodiment of compaction member 740, and includes a pivoting arrangement 678 that permits dual positioning of a handle 760 with respect to the compaction member 740. That is, the handle 760 may be moved from a first position 662 to a second position 664, permitting the handle 760 of the compaction member 740 to be conveniently grasped in order to perform two different tasks. As shown, pivoting arrangement 678 includes a clevis 680, also referred to as a boss or protrusion from the compaction member 740, extending from the second surface 645 of the compaction member 740 through which a sleeve 682 may be inserted. In an alternate embodiment, a clevis 680 may be formed from a different material and secured to the compaction member 740, or other arrangement, if desired. A pair of rods 684 affixed at one end to the sleeve 682 is rotatable about an axis defined by the sleeve 682, with an end opposite rods 684 affixed to the handle 760. As shown, the handle 760 can include an opening 686 that corresponds to securing device 672 (FIG. 1) to secure the compaction device 740 to an exterior surface of the bin 610.

When the pivoting arrangement 678 is rotated in one direction, such as to a first position 662, the handle 760 extends outwardly from the flange 654 of the compaction member 740. That is, the handle 760 is positioned exterior of the footprint of the compaction member 740 and is secured in the first position 662 by a securing device 688, configuring the handle 760 for use as a dustpan. When the pivoting arrangement 678 is rotated in the other direction, such as to a second position 664, the handle 760 extends outwardly from the second surface 645 of the compaction member 740 and is substantially centered with respect to the footprint of the compaction member 740, configuring the handle 760 for use as a grasping instrument when the compaction member 740 is directed within the interior space 655 of the liner 652 (FIG. 8) for purposes of reducing the volume or garbage, also referred to as compaction of the garbage contained in the bin and/or the liner 652. When the handle 760 is located in each of the first position 662 and the second position 664, the handle 760 is secured in the respective position by a securing device 688 located to each side of the pivoting arrangement 678. As shown in FIG. 11, the securing device 688 includes a pair of slits 690 aligned to receive a respective rod 684 from the pivoting arrangement 678, each slit 690 including an enlarged area 692 configured to secure the rod 684 within the slit 690. Securing device 688 is composed of a resilient material that firmly secures the rod 684 within a corresponding slit 690, but also permits manual separation of the rods from the slits 690 without undue force applied in a direction away from the second surface 645 that urges rotational movement of the handle 760 about the axis of the sleeve 682 of the pivoting arrangement 678.

In another embodiment, other arrangements of the handle may be used. For example, the handle may include a second handle portion affixed to the compaction member at a location similar to that of the second position 664. In a further embodiment, the handle corresponding to the first handle position, and further including the second handle portion corresponding to the second handle position, as well as the compaction member may all have a unitary construction, such as being formed by a molding fabrication technique.

While the disclosure has been described with reference to exemplary embodiment, it will be understood by those skilled in the art that various changes may be made and equivalents may be substituted for elements thereof without departing from the scope of the disclosure. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application. It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims. It is therefore intended that the following appended claims and claims hereafter introduced are interpreted to include all such modifications, permutations, additions, and sub-combinations as are within their true spirit and scope.

What is claimed is:

1. A trash container, comprising:
a bin at least partially defining an interior surface having an interior space, the bin having a top, a bottom, and an opening formed in the top in communication with the interior space, the bin configured to vertically support a liner on or near the top of the bin, with the liner being substantially contained within the interior space of the bin; and
a compaction member securable to an exterior surface of the bin between the top and the bottom of the bin, the compaction member configured for insertion in the interior space of the bin to compact an amount of trash disposed within the interior space of the bin.

2. The trash container of claim 1, wherein the compaction member includes a peripheral flange extending away from and at an angle to a first surface of the compaction member, the flange having a first edge and a second edge spaced apart from each other.

3. The trash container of claim 1, wherein the compaction member includes a handle.

4. The trash container of claim 1, wherein the handle is selectably movable between a first position and a second position.

5. The trash container of claim 4, wherein the first position of the handle extends outwardly from a flange of the compaction member.

6. The trash container of claim 4, wherein the second position of the handle extends outwardly from a second surface of the compaction member opposite a first surface of the compaction member.

7. The trash container of claim 1, wherein the handle extends outwardly from a second surface of the compaction member opposite a first surface of the compaction member.

8. The trash container of claim 7, wherein the handle includes a second handle portion extending outwardly from the flange.

9. The trash container of claim 8, wherein the handle and the second handle portion are affixed to the compaction member.

10. The trash container of claim 9, wherein the compaction member, handle and second handle portion have a unitary construction.

11. The trash container of claim 1, wherein the bin includes at least one opening formed near the bottom of the bin.

12. The trash container of claim 11, wherein an opening of the at least one opening is formed in an opposed position of the bin.

13. A trash compaction system, comprising:
a liner defining an interior surface having an interior space;
a trash container comprising:
a bin at least partially defining an interior surface having an interior space, the bin having a top, a bottom, and an opening formed in the top in communication with the interior space, the bin configured to vertically support the liner on or near the top of the bin, with the liner being substantially contained within the interior space of the bin; and
a compaction member securable to an exterior surface of the bin between the top and the bottom of the bin, the compaction member configured for insertion in the interior space of the bin to compact an amount of trash disposed within the interior space or of the liner; and
wherein the compaction member is configured to reduce the volume of trash contained within the liner upon insertion of the compaction member in the interior space of the liner and directed movement of the compaction member toward the bottom of the bin.

14. The trash compaction system of claim 13, wherein the compaction member includes a peripheral flange extending away from and at an angle to a first surface of the compaction member, the flange having a first edge and a second edge spaced apart from each other.

15. The trash container of claim 13, wherein the compaction member includes a handle.

16. The trash compactor of claim 13, wherein the bin includes a closable slit formed in a top and extending toward the bottom of the bin, the slit being selectably openable to assist with removal of liners filled with trash.

17. A method of trash compaction comprising:
providing a bin having a top and a bottom, the bin at least partially defining an interior surface having an interior space;
forming at least one opening in the bin near the bottom;
vertically supporting a liner at least partially in the interior space at or near the top of the bin, the liner defining an interior surface having an interior space;
inserting a compaction member in the interior space of the liner; and
directing the compacting member toward the bottom of the bin.

18. The method of claim 16, wherein the compaction member includes a peripheral flange extending away from and at an angle to a first surface of the compaction member, the flange having a first edge and a second edge spaced apart from each other.

19. The trash container of claim 16, wherein the liner is removable.

20. The trash container of claim 16, wherein prior to inserting a compaction member, a handle of the compaction member is moved from a first position to a second position wherein the second position of the handle extends outwardly from a second surface of the compaction member opposite a first surface of the compaction member.
